(19) United States
(12) Patent Application Publication
(10) Pub. No.: US 2011/0096928 A1
(43) Pub. Date: Apr. 28, 2011

(54) Wireless Communication Base Station Device, Wireless Communication Mobile Station Device, and Method for Scrambling Response Signal in ARQ

(75) Inventors: Masaru Fukuoka, Ishikawa (JP); Akihiko Nishio, Kanagawa (JP); Daichi Imamura, Kanagawa (JP)

(73) Assignee: PANASONIC CORPORATION, Osaka (JP)

(21) Appl. No.: 12/673,020

(22) PCT Filed: Aug. 12, 2008
(86) PCT No.: PCT/JP2008/002200

§ 371 Date: Feb. 11, 2010

(30) Foreign Application Priority Data
Aug. 13, 2007 (JP) 2007-211161

(51) Int. Cl. H04K 1/04

(52) U.S. Cl. 380/270

(57) ABSTRACT

A wireless communication base station device which does not fail in ARQ control even when a mobile station fails to receive allocation information and collision of the uplink data transmitted from mobile stations occurs. In the device, a CRC unit (123) detects an error, if any, in the decoded uplink data by using a CRC and generates a response signal, a modulation unit (105) modulates the response signal, a repetition unit (106) duplicates the modulated response signal and obtains the same response signals, a scrambling code selection unit (107) receives a method of scheduling the uplink data channel from an allocation information generation unit (101) and selects a scrambling code of a PSA mobile station or a DSA mobile station, and a scrambling unit (108) scrambles the response signal with the scrambling code selected by the scrambling code selection unit (107).

### TECHNICAL FIELD

The present invention relates to a radio communication base station apparatus, radio communication mobile station apparatus and method for scrambling response signals in ARQ.

### BACKGROUND ART

In response to the increase in Internet traffic in recent years, the demand for a high speed packet transmission technique in mobile communication is increasing, and the OFDM (Orthogonal Frequency Division Multiplex) scheme is being studied as one transmission scheme to meet that demand. The OFDM scheme makes it possible to reduce deterioration in performance due to multipath interference by transmitting data sequences with CPs (Cyclic Prefixes) in parallel using a plurality of subcarriers. Further, the OFDM scheme provides robustness for frequency selective fading by applying error correcting codes.

The OFDM scheme performs frequency division multiplexing of various downlink channels and further performs time division multiplexing by making a plurality of OFDM symbols one TTI (Transmission Time Interval). There are ACK (Acknowledgment)/HACK (Negative Acknowledgment) channels and allocation information indication channels as control channels on downlink channels.

A response signal channel refers to a channel for feeding back packet reception OK (i.e. ACK) or packet reception NG (i.e. NACK) in a radio communication base station apparatus, to a radio communication mobile station apparatus in uplink packet transmission. That is, with the OFDM scheme, ARQ (Automatic Repeat reQuest) is applied to uplink data that is transmitted in uplink from a radio communication mobile station apparatus to a radio communication base station apparatus. Hereinafter, a radio communication mobile station apparatus is referred to simply as a “mobile station” or “UE (User Equipment),” and a radio communication base station apparatus will be referred to simply as a “base station” or “BS (Base Station).”

Recently, to efficiently use downlink communication resources, ARQ that shares and uses a response signal channel between a plurality of mobile stations is being studied. Further, with this ARQ, the base station feeds back a response signal to a mobile station when a predetermined period passes after uplink data is received, and, in case where a NACK is fed back from the base station, the mobile station retransmits uplink data to the base station when a predetermined period passes after the NACK is received. With this ARQ, information showing to which radio communication mobile station a response signal is addressed is not added to this response signal (see Non-Patent Document 1).

Further, by associating an RB number with a response signal channel number indicated from an allocation information indication channel on a one-to-one basis, it is possible to share the response signal channel number between mobile stations and a base station without indicating this response signal channel number in the allocation information indication channel.

An allocation information indication channel is another kind of a control channel that is different from a response signal channel in a downlink channel of the OFDM scheme, and is a channel for indicating information such as frequency bands and modulation schemes used to transmit uplink data from mobile stations. Allocation information of each mobile station includes mobile station ID information that shows to which mobile station this allocation information is addressed. As mobile station ID information, allocation information includes, for example, CRC bits that are masked based on the ID number of a mobile station to which that allocation information is indicated. A mobile station demasks mobile ID information using the ID number of this mobile station to decide that allocation information showing CRC=OK (i.e. no error) is addressed to this mobile station. By so doing, a mobile station performs blind decision as to whether or not the allocation information indication channel is the allocation information addressed to this mobile station.

By contrast with this, as a scheduling method for transmission RBs (Resource Blocks) of an uplink data channel, PSA (Persistent Scheduling Allocation) and DSA (Dynamic Scheduling Allocation) are being studied. PSA is applied to mobile stations that perform uplink transmission of low rate data e.g. VoIP. PSA mobile stations perform uplink transmission on a regular basis using RBs that are allocated in advance. DSA is a method of performing uplink transmission by adaptively allocating RBs of good reception performance using frequency scheduling, and is directed to receiving indication of RBs through an allocation information indication channel, in uplink transmission per TTI. Non-Patent Document 1: “Modifications of Uplink Synchronous HARQ scheme,” LG Electronics, 3GPP RAN WG1 Meeting Document, R1-070245

### DISCLOSURE OF INVENTION

### Problems to be Solved by the Invention

In case where PSA mobile stations allow uplink transmission using RBs other than RBs allocated in advance, the base station additionally indicates new uplink transmission RBs through an allocation information indication channel, to the PSA mobile stations. For example, there are cases where RB 1 allocated in advance to a PSA mobile station is allocated to a DSA mobile station and a new RB 2 is allocated to the PSA mobile station. However, there are cases where mobile stations fail to receive allocation information indication channels. Further, in case where a PSA mobile station fails to receive an allocation information indication channel, the PSA mobile station continues uplink transmission using an RB allocated in advance and therefore, uplink data from the PSA mobile station collides with uplink data from the DSA mobile station.

FIG. 1 shows such collision between uplink transmission of a PSA mobile station and uplink transmission of a DSA mobile station. In the following description, assume that a base station feeds back response signals to mobile stations when one TTI passes after uplink data is received, and the mobile stations retransmit uplink data to the base station when one TTI passes after a NACK is received. Further, before time t1, RB 1 is allocated in advance to the PSA mobile station.

At time t1, the base station transmits allocation information showing that RB 2 is going to be allocated to the PSA mobile station, to the PSA mobile station, and transmits allocation information showing that RB 1 is going to be allocated to the DSA mobile station, to the DSA mobile station. For example, this happens in case where, when channel quality of RB 1 is better than RB 2 of channel quality in the DSA mobile station, the DSA mobile station is subjected to frequency scheduling for RB 1.

Here, assume that the PSA mobile station fails to receive the allocation information indication channel at time t2. Therefore, the PSA mobile station performs initial transmission of new uplink data at time t3 using RB 1 allocated in advance before time t1.

The DSA mobile station successfully receives the allocation information indication channel at time t2, and transmits new uplink data for the first time at time t3 using the allocated RB 1.

In this way, in case where the PSA mobile station fails to receive the allocation information indication channel at time t2, the PSA mobile station and DSA mobile station both transmit uplink data using RB 1 at time t3, and therefore collision takes place. As a result, when the base station receives uplink data from the DSA mobile station at time t4, this uplink data is interfered by uplink data of the PSA mobile station, and therefore there is a higher probability that reception NG occurs. Then, the base station feeds back a NACK at time t5 using response signal number 1 associated with RB 1. Further, although the base station receives uplink data from the PSA mobile station in RB 2, the PSA mobile station does not perform transmission using RB 2, and therefore the CRC result becomes NG. Accordingly, the base station feeds back a NACK at time t5 using response signal number 2 associated with RB 2.

The PSA mobile station transmitted uplink data at time t3 using RB 1, and therefore decides that the NACK fed back using response signal channel number 1 is addressed to the PSA mobile station, assuming that the base station transmits a response signal at time t5 using response signal channel number 1 associated with RB 1. Thus, the PSA mobile station retransmits (for the first time) uplink data at time t7.

By contrast with this, the DSA mobile station transmitted uplink data using RB 1 at time t3, and therefore receives a NACK fed back from the base station at time t5, based on the decision that this NACK is addressed to the DSA mobile station. Thus, the DSA mobile station retransmits (for the first time) uplink data at time t7.

Due to the above reason, retransmission data from the PSA mobile station collides with retransmission data from the DSA mobile station, and, as a result, there is a higher probability that the CRC result in the base station becomes NG (i.e. error present). Therefore, the base station feeds back a NACK at time t9.

Subsequently, a series of processings of uplink data transmission from the PSA mobile station and DSA mobile station, collision between uplink data, CRC=NG (i.e. error present), feedback of a NACK, uplink data transmission from the PSA mobile station and DSA mobile station, are repeated, and ARQ control does not operate normally.

As described above, with ARQ for sharing and using a response signal channel between a plurality mobile stations, when a PSA mobile station fails to receive an allocation information indication channel and uplink data from the PSA mobile station collides with uplink data from a DSA mobile station in the same RB, there is a problem that ARQ control collapses.

It is therefore an object of the present invention to provide a base station, mobile station and a method for scrambling response signals in ARQ that can prevent collapse of ARQ control even in case where a PSA mobile station fails to receive an allocation information indication channel and uplink data from the PSA mobile station collides with uplink data from a DSA mobile station in the same RB in ARQ for sharing and using a response signal channel between a plurality of mobile stations.

### Means for Solving the Problem

The base station according to the present invention employs a configuration which includes: an error detecting section that generates a response signal by performing error detection; a selecting section that selects one of a plurality of scrambling codes; and a scrambling section that scrambles a response signal using the scrambling code selected in the selecting section.

The method for scrambling a response signal in automatic repeat request, according to the present invention includes using a scrambling code that varies between a response signal that is a response signal to data transmitted in uplink using uplink allocation information and a response signal that is a response signal to data in uplink without using the uplink allocation information.

### ADVANTAGEOUS EFFECTS OF INVENTION

The present invention can prevent collapse of ARC control even in case where a PSA mobile station fails to receive an allocation information indication channel and uplink data from the PSA mobile station collides with uplink data from a DSA mobile station in ARQ for sharing and using a response signal between a plurality of mobile stations.

### BRIEF DESCRIPTION OF DRAWINGS

FIG. 1 shows an example of a sequence of ARQ;

FIG. 2 is a block diagram showing the configuration of a base station according to Embodiment 1;

FIG. 3 is a block diagram showing the configuration of a mobile station according to Embodiment 1;

FIG. 4 shows an example of a sequence of ARQ according to Embodiment 1;

FIG. 5 shows a constellation pattern according to Embodiment 1;

FIG. 6 shows an example of scrambling according to Embodiment 1;

FIG. 7 shows an example of descrambling according to Embodiment 1 (in a PSA mobile station);

FIG. 8 shows an example of decision according to Embodiment 1;

FIG. 9 shows an example of descrambling according to Embodiment 1 (in a DSA mobile station);

FIG. 10 shows a constellation pattern according to Embodiment 2;

FIG. 11 is a block diagram showing the configuration of a base station according to Embodiment 2;

FIG. 12 shows an example of a sequence of ARQ according to Embodiment 2;

FIG. 13 shows an example of scrambling according to Embodiment 2;

FIG. 14 shows an example of descrambling according to Embodiment 2 (in a PSA mobile station);

FIG. 15 shows an example of descrambling according to Embodiment 2 (in a DSA mobile station);

FIG. 16 shows an example of a sequence of ARQ according to Embodiment 3;

FIG. 17 is a block diagram showing the configuration of a base station according to Embodiment 3;

FIG. 18 is a block diagram showing the configuration of a mobile station according to Embodiment 3;

FIG. 19 shows an example of a sequence of ARQ according to Embodiment 3;

FIG. 20 shows an example of scrambling according to Embodiment 3;

FIG. 21 shows an example of descrambling according to Embodiment 3 (in DSA mobile station 1);

FIG. 22 shows an example of descrambling according to Embodiment 3 (in DSA mobile station 2);

FIG. 23 shows another example of a response signal;

FIG. 24 shows an example of phase rotation (in mobile station 1);

FIG. 25 shows an example of phase rotation (in mobile station 2); and

FIG. 26 shows another example of decision.

### BEST MODE FOR CARRYING OUT THE INVENTION

Hereinafter, embodiments of the present invention will be explained in detail with reference to the accompanying drawings.

### Embodiment 1

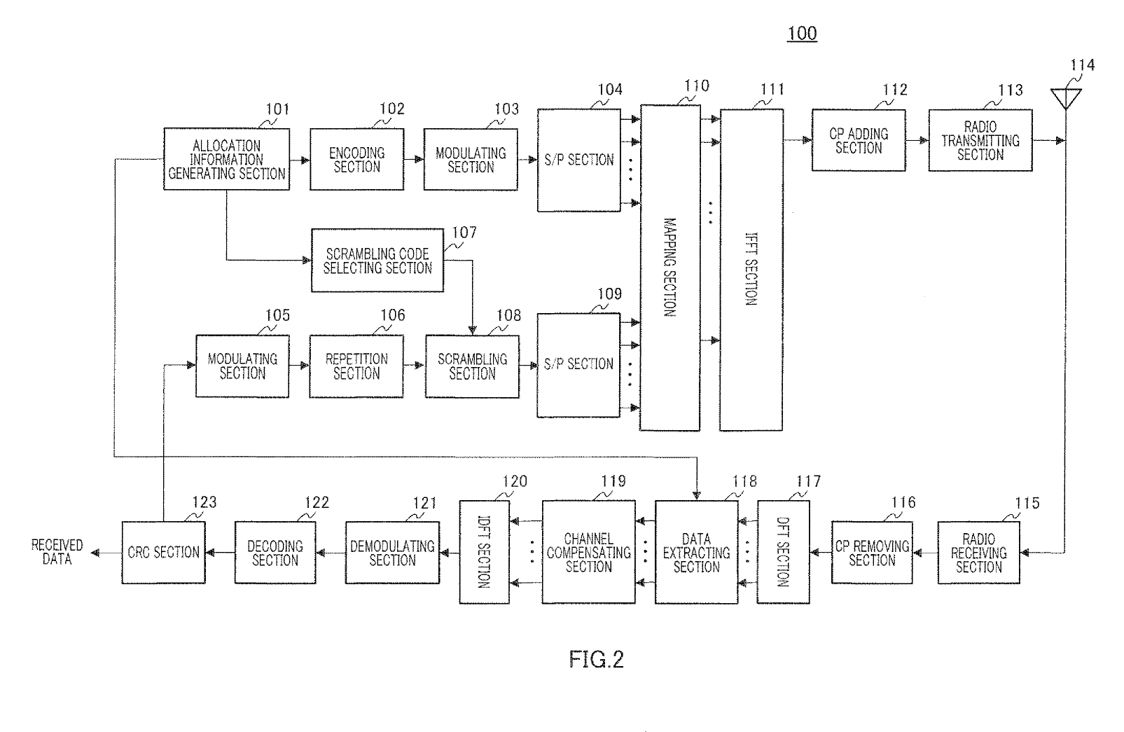

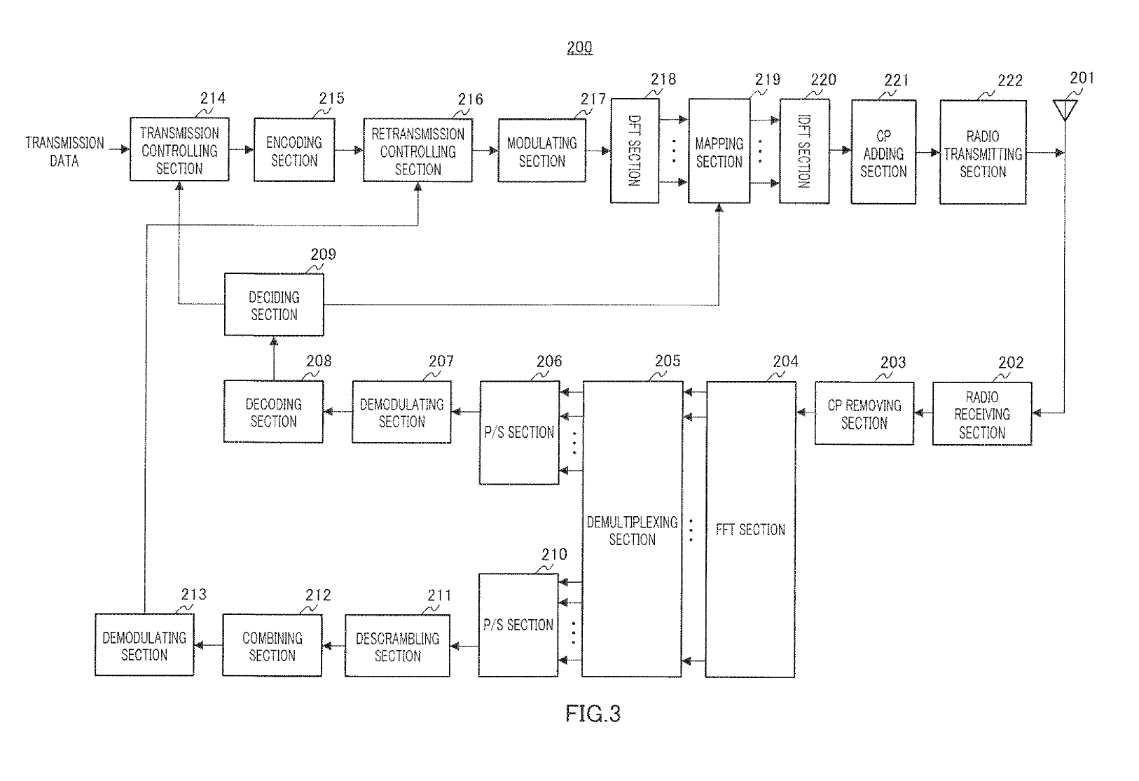

FIG. 2 shows the configuration of base station 100 according to the present embodiment, and FIG. 3 shows the configuration of mobile station 200 according to the present embodiment.

Note that, to avoid complication of explanation, FIG. 2 shows components that relate to reception of uplink data and downlink transmission of a response signal for this uplink data where both of these reception and downlink transmission are closely related to the present invention, and illustration and explanation of components that relate to transmission of downlink data will be omitted. Similarly, FIG. 3 shows components that relate to transmission of uplink data and downlink reception of a response signal for this uplink data where both of these transmission and downlink reception are closely related with the present invention, and illustration and explanation of components that relate to reception of downlink data will be omitted.

In base station 100 shown in FIG. 2, allocation information generating section 101 generates allocation information showing to which mobile station an uplink data channel is going to be allocated, and outputs this allocation information to encoding section 102 and data extracting section 118. Further, allocation information generating section 101 outputs an ID number of a mobile station to which the generated allocation information is indicated, to encoding section 102, and outputs a method for scheduling the uplink data channel of the mobile station of the indication destination, that is, information showing PSA or DSA, to scrambling code selecting section 107.

Encoding section 102 encodes the allocation information and outputs the allocation information to modulating section 103. At this time, encoding section 102 generates a plurality of CRC bits from the allocation information, and masks a plurality of these CRC bits using a mobile ID number inputted from allocation information generating section 101. Accordingly, as mobile station ID information, the allocation information includes CRC bits that are masked using the ID number of the mobile station to which this allocation information is indicated.

Modulating section 103 generates a plurality of allocation information symbols by modulating the encoded allocation information, and outputs a plurality of allocation information symbols to S/P section 104.

S/P section 104 converts a plurality of allocation information symbols inputted from modulating section 103 from serial to parallel, and outputs these symbols to mapping section 110.

Modulating section 105 performs modulation processing of the response signal (i.e. ACK or HACK) for uplink data, and outputs the response signal subjected to modulation processing, to repetition section 106.

Repetition section 106 acquires a plurality of identical response signals by repeating the response signal inputted from modulating section 105 (i.e. repetition), and outputs a plurality of these response signals to scrambling section 108.

Scrambling code selecting section 107 receives the method for scheduling an uplink data channel, from allocation information generating section 101, selects a scrambling code for a PSA mobile station or a DSA mobile station and outputs the scrambling code to scrambling section 108.

Scrambling section 108 scrambles a plurality of identical response signals using the scrambling code received as input from scrambling code selecting section 107, and outputs a plurality of scrambled response signals to S/P section 109.

The selection processing in scrambling code selecting section 107 and scrambling processing in scrambling section 108 will be described in detail below.

S/P section 109 converts a plurality of response signals received as input from scrambling section 108 from serial to parallel, and outputs these signals to mapping section 110.

Mapping section 110 maps the allocation information symbols and response signals on a plurality of subcarriers forming an OFDM symbol, and outputs the OFDM symbol to IFFT (Inverse Fast Fourier Transform) section 111.

IFFT section 111 performs an IFFT of the allocation information symbols and response signals mapped on a plurality of subcarriers to generate an OFDM symbol, and outputs the OFDM symbol to CP (Cyclic Prefix) adding section 112.

CP adding section 112 adds the same signal as the rear portion of the OFDM symbol, to the head of that OFDM symbol as a CP.

Radio transmitting section 113 performs transmission processing such as D/A conversion, amplification and up-conversion, with respect to the OFDM symbol to which CP is added, and transmits the OFDM symbol to mobile station 200 from antenna 114.

By contrast with this, radio receiving section 115 receives at antenna 114 uplink data transmitted from mobile station 200, and performs receiving processing such as down-conversion and A/D conversion with respect to this uplink data.

CP removing section 116 removes the CP added to the uplink data subjected to A/D conversion.

DFT (Discrete Fourier Transform) section 117 transforms uplink data, from which CP is removed, into frequency domain data.

Data extracting section 118 extracts data by receiving an RB number allocated as an uplink data channel in allocation information received as input from allocation information generating section 101. The extracted data is subjected to channel compensation in channel compensating section 119, and is further converted back to time domain data in IDFT (Inverse Discrete Fourier Transform) section 120.

Demodulating section 121 demodulates time domain uplink data, and outputs the demodulated uplink data to decoding section 122.

Decoding section 122 decodes the demodulated uplink data, and outputs the decoded uplink data to CRC section 123.

CRC section 123 performs error detection of the decoded uplink data using CRC, and generates an ACK as a response signal if CRC=OK (i.e. no error) or generates a NACK as a response signal if CRC=NG (i.e. error present) and outputs the generated response signal to modulating section 105. Further, CRC section 123 outputs the decoded uplink data as received data if CRC=OK (i.e. no error).

By contrast with this, in mobile station 200 shown in FIG. 3, radio receiving section 202 receives through antenna 201 the OFDM symbol transmitted from base station 100, and performs receiving processing such as down-conversion and A/D conversion, with respect to this OFDM symbol.

CP removing section 203 removes the CP from the OFDM symbol subjected to receiving processing.

FFT (Fast Fourier Transform) section 204 performs an FFT of the OFDM symbol from which the CP is removed, to acquire allocation information symbols and response signals, and outputs these to demultiplexing section 205.

Demultiplexing section 205 demultiplexes the allocation information symbols and response signals, and outputs the allocation information symbols to P/S section 206 and outputs the response signals to P/S section 210.

P/S section 206 converts a plurality of allocation information symbols received as input from demultiplexing section 205 from parallel to serial, and outputs these symbols to demodulating section 207.

Demodulating section 207 demodulates the allocation information symbols, and outputs the demodulated allocation information to decoding section 208.

Decoding section 208 decodes the demodulated allocation information, and outputs the decoded allocation information to deciding section 209.

Deciding section 209 performs blind decision as to whether or not the allocation information indication channel received as input from decoding section 208 is addressed to mobile station 200. Deciding section 209 demasks the allocation information received as input from decoding section 208 using the ID number of mobile station 200, and decides that the resulting allocation information indication channel showing CRC=OK (i.e. no error) is addressed to mobile station 200. Then, deciding section 209 outputs the allocation information showing CRC=OK (i.e. no error) (that is, allocation information addressed to mobile station 200), to transmission controlling section 214.

P/S section 210 converts a plurality of response signals received as input from demultiplexing section 205 from parallel to serial, and outputs these signals to descrambling section 211.

Descrambling section 211 descrambles a plurality of response signals received as input from P/S section 210, using a scrambling code matching the scheduling scheme of mobile station 200 (that is, a scrambling code supporting PSA or DSA), and outputs a plurality of these descrambled response signals to combining section 212.

Combining section 212 combines a plurality of descrambled response signals, and outputs the combined response signal to demodulating section 213.

Note that the details of the descrambling processing in descrambling section 211 and the details of combining processing in combining section 212 will be described later.

Demodulating section 213 performs demodulating processing of the combined response signal, and decides whether the signal subjected to demodulating processing is an ACK, a NACK or DTX (Discontinuous Transmission). Then, demodulating section 213 outputs the decision result to retransmission controlling section 216.

Transmission controlling section 214 packetizes transmission data based on the allocation information from deciding section 209, and outputs the packetized transmission data to encoding section 215.

Encoding section 215 encodes the transmission data, and outputs the transmission data to retransmission controlling section 216.

Upon initial transmission, retransmission controlling section 216 holds the encoded transmission data and outputs the transmission data to modulating section 217. Retransmission controlling section 216 holds the transmission data until an ACK is received as input from demodulating section 213 as a decision result, and discards the transmission data when an ACK is received as input. Further, when a NACK is received as input from demodulating section 213 as a decision result, that is, when retransmission is performed, retransmission controlling section 216 outputs the transmission data that is held, again to modulating section 217. Further, when DTX is received as input from demodulating section 213 as the decision result, retransmission controlling section 216 stops uplink transmission while holding the transmission data.

Modulating section 217 modulates encoded transmission data received as input from retransmission controlling section 216.

DFT section 218 converts the modulated transmission data into frequency domain data, and mapping section 219 maps the frequency domain transmission data on an uplink transmission RB number shown by the allocation information acquired in deciding section 209.

IDFT section 220 converts the frequency domain transmission data mapped on the uplink transmission RB, into time domain data, and outputs the time domain data to CP adding section 221.

CP adding section 221 adds the same signal as the rear portion of the time domain transmission data, to the head of that transmission data as a CP.

Radio transmitting section 222 performs transmission processing such as D/A conversion, amplification and up-conversion, with respect to the transmission data to which CP is added, and transmits the transmission data to base station 100 from antenna 201. The data transmitted in this way becomes uplink data.

The configuration of mobile station 200 shown in FIG. 3 is applicable to the DSA mobile station and PSA mobile station. Note that, in case where mobile station 200 is a PSA mobile station and an RB is not additionally allocated from base station 100, FFT section 204 cannot acquire allocation information symbols and can only acquire response signals. In this case, the PSA mobile station performs uplink transmission using the RB number allocated in advance.

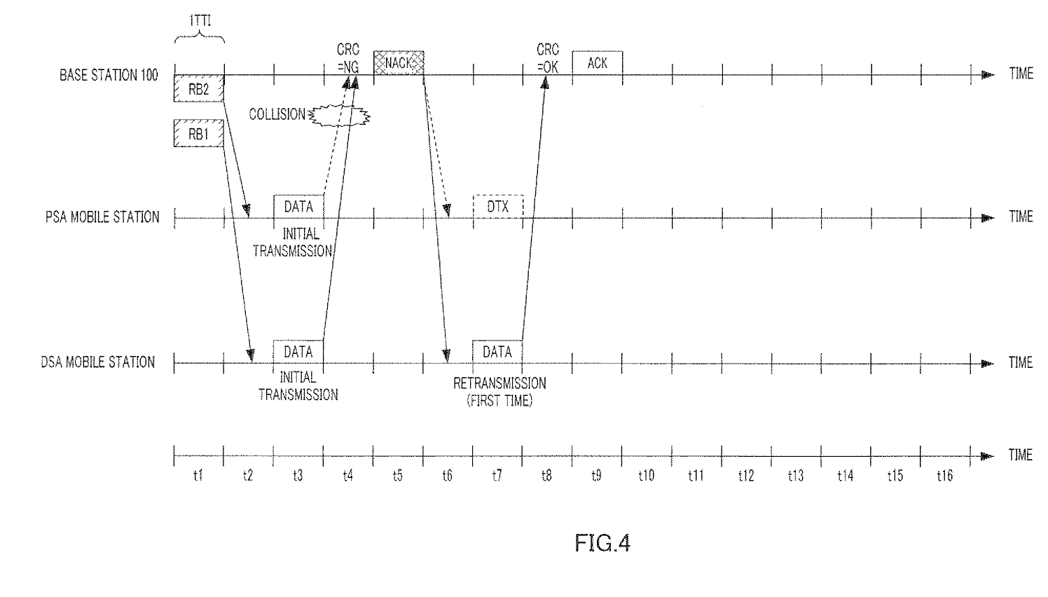

Next, the scrambling processing in scrambling section 108 of base station 100, the descrambling processing in descrambling section 211 of mobile station 200 and the combining processing in combining section 212 of mobile station 200 will be explained in detail based on an example of a sequence shown in FIG. 4.

Assume that the scrambling code for the PSA mobile station (the scrambling code unique to the PSA mobile station) is SC#1(C1,C2)=(1,1), and the scrambling code for the DSA mobile station (the scrambling code unique to the DSA mobile station) is SC#2(C1,C2)=(1,−1). Note that RB 1 is allocated in advance to the PSA mobile station before time t1.

Further, the PSA mobile station and DSA mobile station both employ the configuration shown in FIG. 3.

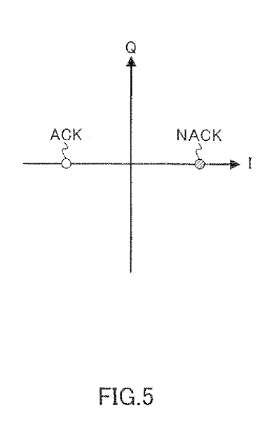

Furthermore, the constellation pattern (a constellation pattern of a response signal) in modulating section 105 of base station 100 is as shown in FIG. 5. That is, modulating section 105 performs BPSK modulation of response signals.

Further, the repetition factor in repetition section 106 of base station 100 is RF=2, and repetition section 106 performs double repetition. Consequently, repetition section 106 can acquire two identical response signals.

In FIG. 4, first, base station 100 transmits allocation information showing that RB 2 of the uplink data channel is going to be allocated to the PSA mobile station, and allocation information showing that RB 1 of the uplink data channel is going to be allocated to the DSA mobile station.

Assume that the PSA mobile station fails to receive the allocation information indication channel from base station 100 at time t2. Therefore, the PSA mobile station performs initial transmission of the uplink data at time t3 using RB 1 allocated in advance before time t1.

By contrast with this, assume that the DSA mobile station can accurately receive the allocation information indication channel from base station 100 at time t2. Thus, the DSA mobile station performs initial transmission of uplink data at time t3 using RB 1.

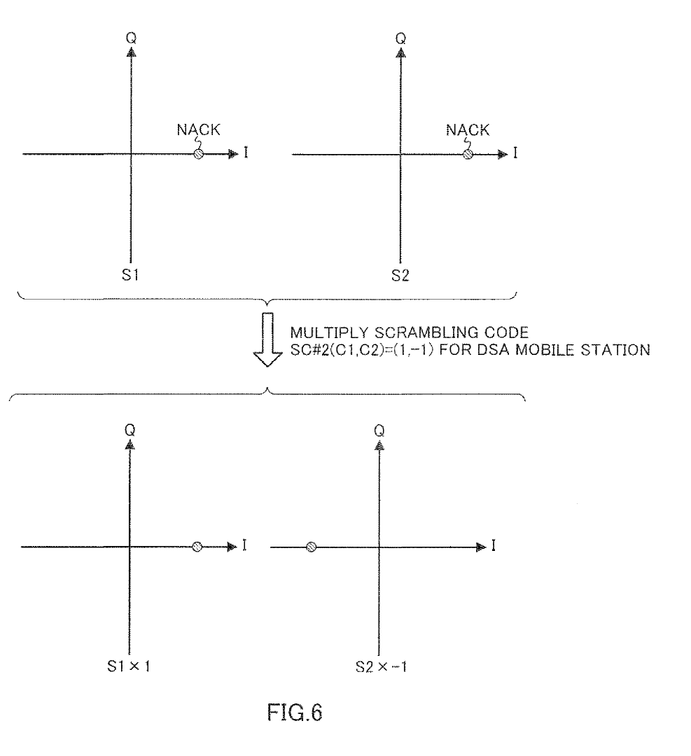

Therefore, at time t4, initial transmission data from the PSA mobile station and initial transmission data from the DSA mobile station are transmitted in RB 1, and therefore collision takes place. As a result, the uplink data of the DSA mobile station in RB 1 is interfered by the uplink data of the PSA mobile station, and therefore there is a higher probability of reception NG in base station 100. Accordingly, base station 100 feeds back a NACK at time t5 using response signal channel number 1 associated with RB 1. At this time, scrambling code selecting section 107 selects scrambling code SC#2(C1,C2) for the DSA mobile station. Hence, as shown in FIG. 6, scrambling section 108 scrambles two HACK symbols (S1 and S2) outputted from repetition section 106 using scrambling code SC#2 (C1, C2) for the DSA mobile station. That is, scrambling section 108 multiplies the two NACK symbols S1 and S2 with 1 and −1. Accordingly, the response signals fed back from base station 100 become S1×1 and S2×−1 as shown in FIG. 6.

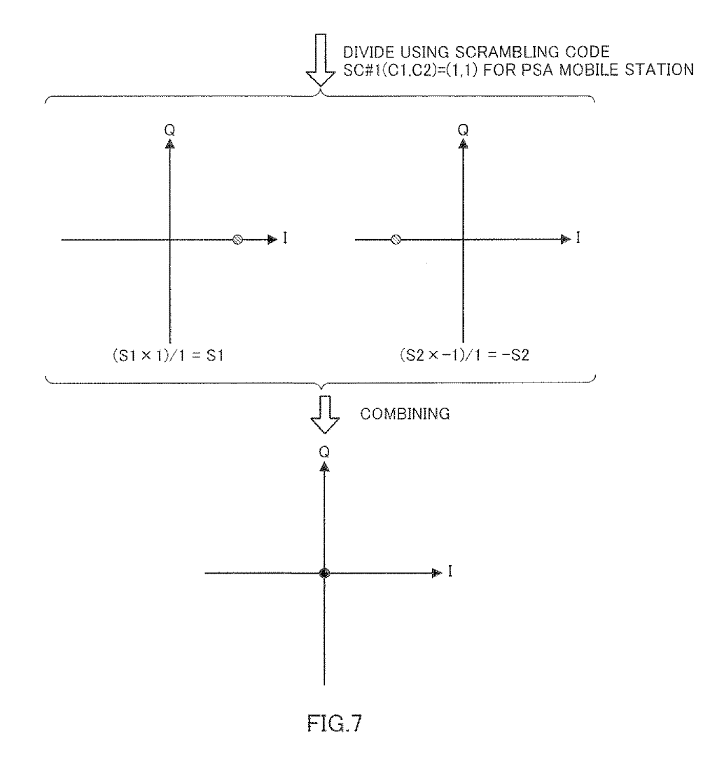

The PSA mobile station performs initial transmission of uplink data using RB 1 at time t3, and therefore receives from base station 100 a response signal of response signal channel number associated with RB 1 at time t5, based on the decision that this response signal is addressed to the PSA mobile station. At this time, as shown in FIG. 7, descrambling section 211 of the PSA mobile station descrambles two response signals outputted from P/S section 210, that is, S1×1 and S2×−1 shown in FIG. 6, using scrambling code SC#1 for the PSA mobile station. That is, descrambling section 211 of the PSA mobile station divides two symbols S1×1 and S2×−1 by 1 and 1, respectively. As a result, descrambling section 211 of the PSA mobile station acquires the constellation point arrangement of S1 and −S2 shown in FIG. 7.

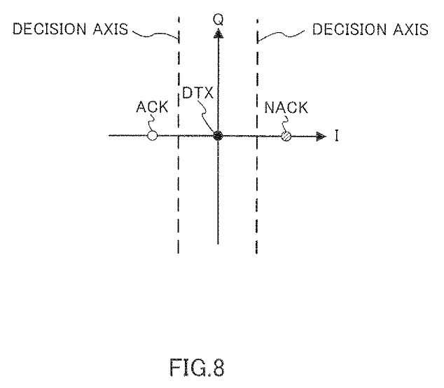

Next, combining section 212 of the PSA mobile station combines S1 and −S2 received as input from descrambling section 211. As a result, the combined symbol is mapped on the constellation point of (I,Q)=(0,0) as shown in FIG. 7. Then, demodulating section 213 of the PSA mobile station decides this combined symbol based on the decision axis shown in FIG. 8. Thus, the PSA mobile station decides that the response signal (i.e. NACK) from base station 100 is DTX. Further, in case where the PSA mobile station decides that the response signal is DTX, the PSA mobile station decides that the RB used in uplink transmission at time t3 is the RB that was allocated to another mobile station and the RB that was allocated to another mobile station was used by error. Thus, the PSA mobile station does not retransmit uplink data at time t7. That is, the PSA mobile station can stop erroneous transmission of uplink data.

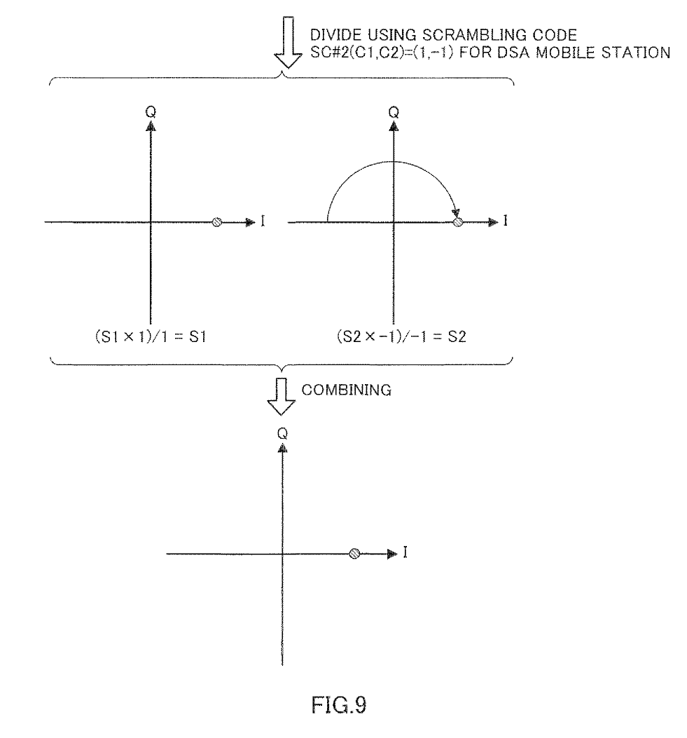

By contrast with this, the DSA mobile station performs initial transmission of uplink data at time t3 using RB 1, and therefore receives from base station 100 the response signal of response signal channel number 1 associated with RB 1 at time t5, based on the decision that the signal is addressed to the DSA mobile station. At this time, as shown in FIG. 9, descrambling section 211 of the DSA mobile station descrambles two response signals outputted from P/S section 210, that is, S1×1 and S2×−1 shown in FIG. 6, using scrambling code SC#2 for the DSA mobile station. That is, descrambling section 211 of the DSA mobile station divides two symbols S1×1 and S2×−1 by 1 and −1, respectively. Thus, descrambling section 211 of the DSA mobile station can acquire the constellation point arrangement of S1 and S2 shown in FIG. 9.

Next, combining section 212 of the DSA mobile station combines S1 and S2 received as input from descrambling section 211. Thus, as shown in FIG. 9, the combined symbol is mapped on the constellation point (see FIG. 5) of a NACK of base station 100. Then, similar to demodulating section 213 of the PSA mobile station, demodulating section 213 of the DSA mobile station decides this combined symbol based on the decision axis shown in FIG. 8. Thus, the DSA mobile station decides that the response signal addressed to the DSA mobile station from base station 100 is a NACK. Therefore, the DSA mobile station retransmits (for the first time) uplink data at time t7.

Accordingly, at time t8, uplink data from the PSA mobile station does not collide with uplink data from the DSA mobile station.

In this way, according to the present embodiment, in a mobile communication system that performs ARQ control by sharing a response signal channel between a plurality of mobile stations, scrambling codes unique to a DSA mobile station or PSA mobile station are provided on the response signal channel. Therefore, even in case where the PSA mobile station fails to receive an allocation information indication channel, uplink data from the PSA mobile station collides with uplink data from the DSA mobile station and the PSA mobile station erroneously receives a response signal channel for the DSA mobile station, the PSA mobile station decides that the response signal channel is not addressed to the PSA mobile station and stops uplink transmission using a wrong RB, so that it is possible to prevent collapse of ARQ control.

Further, although a case has been explained with the present embodiment as an example where the PSA mobile station and DSA mobile station both perform ternary decision of an ACK, NACK and DTX upon reception, the present invention is not limited to this and only the PSA mobile station may perform ternary decision.

Further, in case where the PSA mobile station performs ternary decision, decision error is likely to occur in a response signal channel compared to the case where binary decision is performed. Therefore, preferably, the response signal channel is transmitted at the timing to perform ternary decision in the PSA mobile station, in a reliable manner. As a reliable transmission method, a method of, for example, increasing transmission power, increasing the repetition factor or decreasing the MCS level is possible.

Further, although a case has been explained with the present embodiment as an example where BPSK modulation is performed with respect to response signals, the present invention is not limited to this, and OOK (On Off Keying) modulation for transmitting only a NACK signal may be performed and the details thereof will be described later.

Further, the base station, mobile station and scrambling method according to the present embodiment can prevent collapse of ARQ control not only in case where uplink data from a PSA mobile station that fails to receive an allocation information indication channel collides with uplink data from a DSA mobile station, but also in case where uplink data retransmitted from the DSA mobile station collides with uplink data transmitted for the first time from another DSA mobile station, and details thereof will be described later.

### Embodiment 2

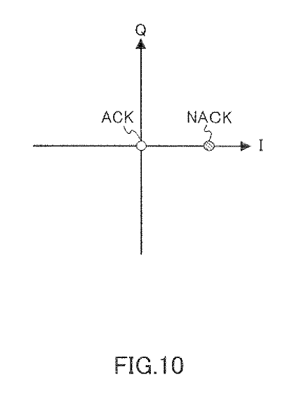

A case will be explained with Embodiment 2 of the present invention where response signals are subjected to OOK modulation based on the constellation pattern shown in FIG. 10.

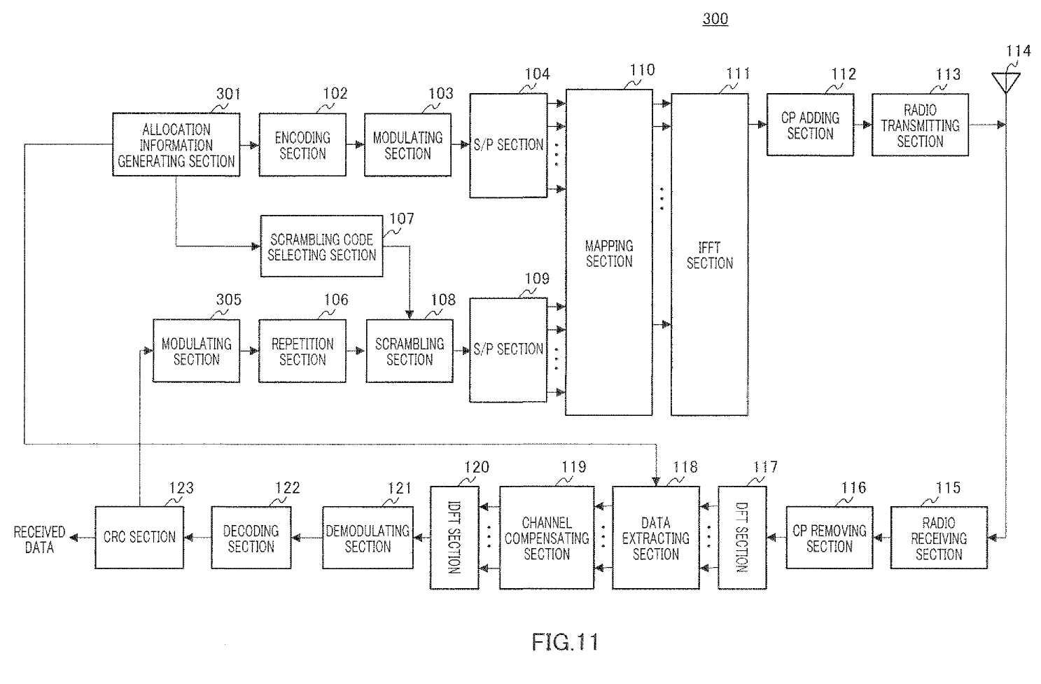

FIG. 11 is a block diagram showing the configuration of base station 300 according to an embodiment of the present invention. Further, base station 300 has the same basic configuration and performs the same basic operation as base station 100 (see FIG. 2) according to Embodiment 1. Only the differences between base station 300 and base station 100 will be explained here.

Allocation information generating section 301 and modulating section 305 of base station 300 differ from allocation information generating section 101 and modulating section 105 of base station 100 in part of the processing, and therefore will be assigned different reference numerals to indicate these differences.

Modulating section 305 differs from modulating section 105 in performing OOK modulation of a response signal (i.e. ACK or NACK).

Allocation information generating section 301 differs from allocation information generating section 101 in adding NDI (New Data Indicator) to an allocation information indication channel.

The mobile station according to the present embodiment has the same basic configuration and the same basic processing as in mobile station 200 (see FIG. 3) according to Embodiment 1, and therefore detailed explanation thereof will be omitted.

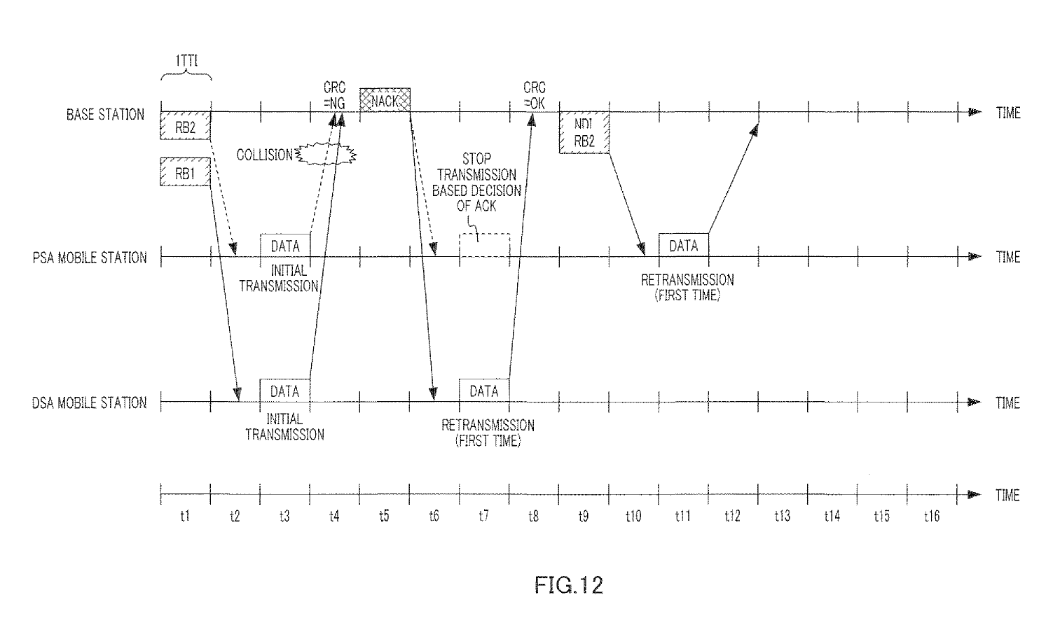

With the present embodiment, the base station performs OOK modulation of response signals, and mobile stations perform binary decision to decide whether the response signal is ACK or NACK. That is, in case where the PSA mobile station fails to receive an allocation information indication channel and the response signal that is transmitted from the PSA mobile station for the first time is mapped on the constellation point of (I,Q)=(0,0), the PSA mobile station decides that an ACK is received. However, if the PSA mobile station decides by error that uplink data transmitted using RB 1 is received successfully by the base station, the base station cannot actually receive the uplink data and therefore retransmission takes place in an upper layer. In order to prevent this, when the base station transmits the next allocation information indication channel, the base station indicates using NDI that the same data as the uplink data that was previously transmitted needs to be transmitted. By this means, the PSA mobile station can decide that the received ACK signal is addressed to other mobile station and reception of an allocation information indication channel fails. Then, the PSA mobile station performs uplink transmission of the same data again. This processing will be explained using FIG. 12 to FIG. 14.

FIG. 12 is a sequence diagram showing processings in the base station and mobile station according to the present embodiment.

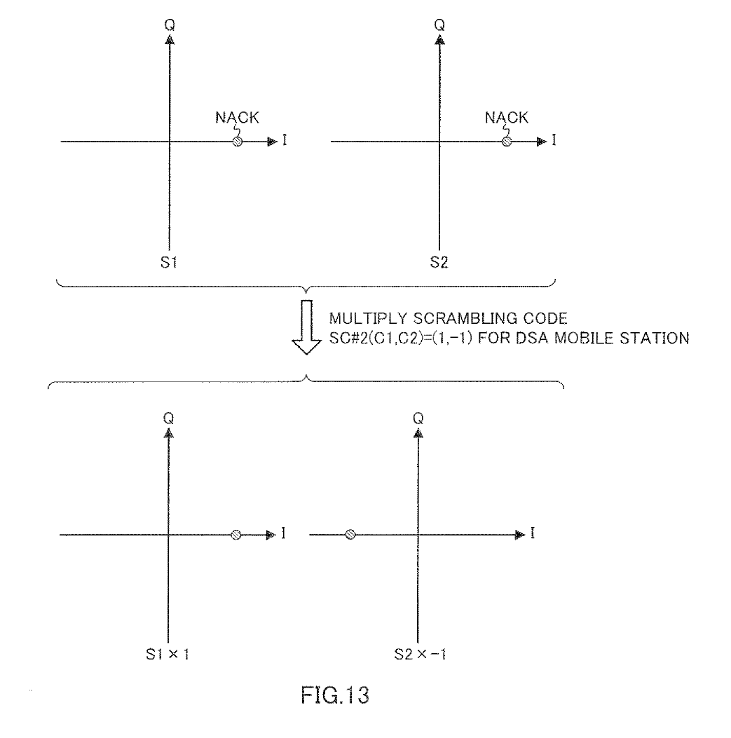

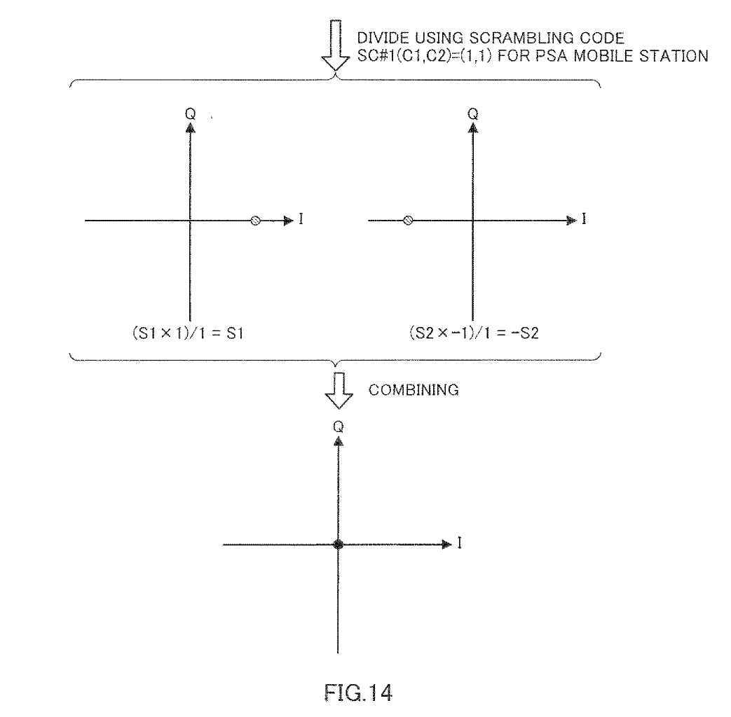

FIG. 12 and FIG. 4 are basically the same, and only differences will be explained. When the base station transmits a NACK at time t5 shown in FIG. 12, the base station scrambles two NACK symbols (S1 and S2) as shown in FIG. 13 using scrambling code SC#2(C1,C2)=(1,−1) for the DSA mobile station, and transmits the resulting response signals S1×1 and S2×−1. As shown in FIG. 14, the PSA mobile station descrambles and combines two received response signals S1×1 and S2×−1 using scrambling code SC#1=(1,1) at time t7, and acquires a combined symbol mapped on the constellation point of (I,Q)=(0,0). The PSA mobile station stops transmission based on this combined signal (i.e. ACK). By contrast with this, as shown in FIG. 15, at time t7, the DSA mobile station descrambles and combines two received response signals S1×1 and S2×−1 using scrambling code SC#2=(1,−1) for the DSA mobile station, and acquires the combined symbol of a NACK (see FIG. 10). The DSA mobile station performs retransmission based on this combined signal (i.e. NACK). Then, at time t9, when transmitting the allocation information indication channel (that is, when indicating uplink transmission using RB 2), the base station indicates NDI together. At this time, the base station transmits “0” as NDI. In case where NDI is “0,” NDI is directed to commanding retransmission of uplink data that was previously transmitted and, in case where NDI is “1,” NDI is directed to commanding initial transmission of new uplink data. By reading NDI of “0,” the PSA mobile station that received allocation information recognizes that the ACK signal received at time t7 is addressed to another mobile station, and performs uplink transmission of the same data again.

In this way, according to the present embodiment, in case where the base station performs OOK modulation of response signals, the PSA mobile station stops uplink transmission based on the decision that the response signal channel is not addressed to the PSA mobile station and is an ACK signal, so that it is possible is to prevent collapse of ARQ control. Further, the base station transmits the next allocation information and NDI (=0) to the PSA mobile station that stops transmission, so that the PSA mobile station can recognize that the result of previous uplink transmission is not an ACK and the PSA mobile station fails to receive allocation information, and retransmit the same data.

### Embodiment 3

The base station, mobile station and scrambling method that can prevent collapse of ARQ control in case where uplink data retransmitted from a DSA mobile station collides with uplink data transmitted for the first time from another DSA mobile station, will be explained with Embodiment 3 of the present invention.

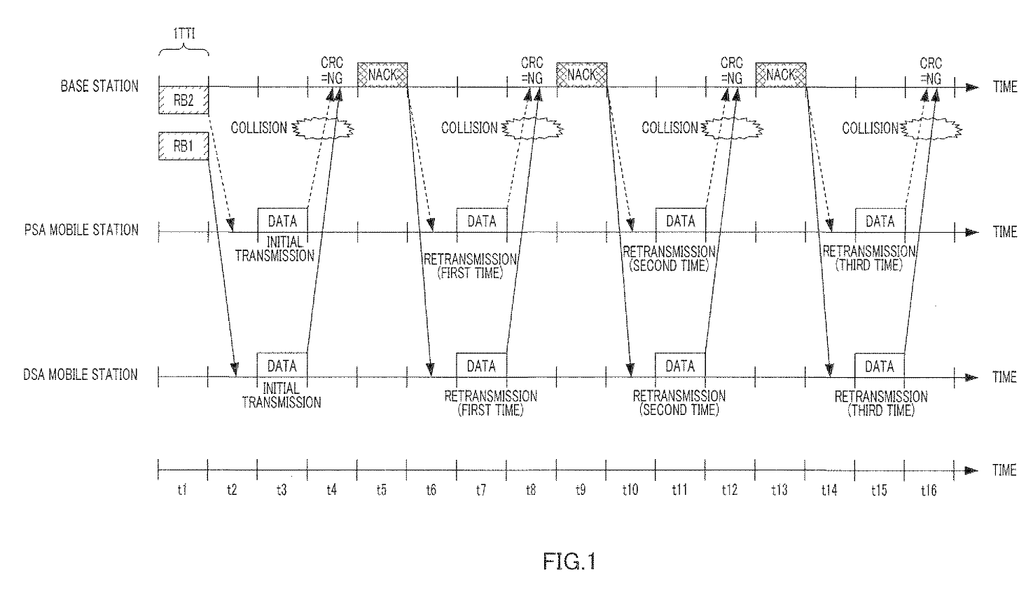

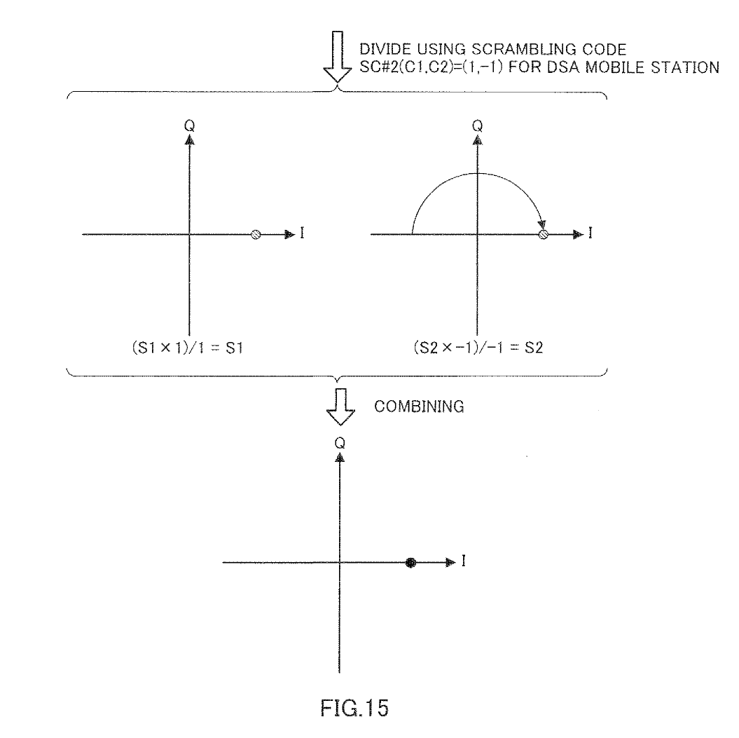

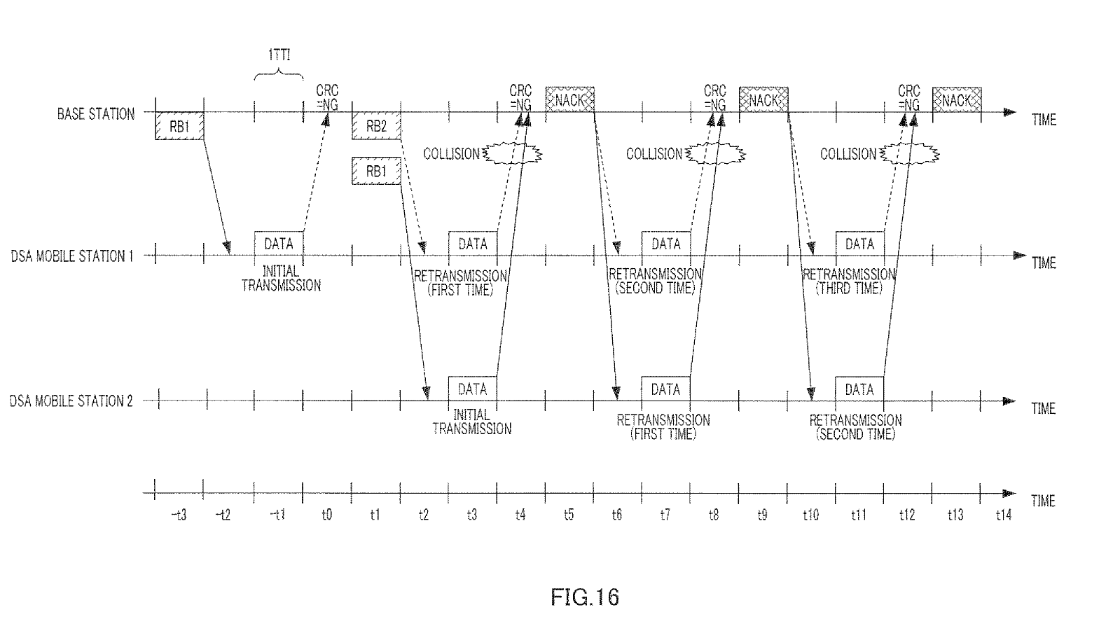

FIG. 16 shows that uplink data retransmitted from the DSA mobile station collides with uplink data transmitted for the first time from other DSA mobile stations. Note that FIG. 16 and FIG. 1 are basically the same, and therefore only the differences between FIG. 16 and FIG. 1 will be explained.

In FIG. 1, in case where the PSA mobile station performs uplink transmission before time t1 using RB 1 that is allocated in advance and fails to receive allocation information (i.e. RB 2) from the base station at time 1, the PSA mobile station performs uplink transmission using RB 1 again at time t3. Similar to this, in FIG. 16, in case where the DSA mobile station 1 receives allocation information (i.e. RB 1) before time t1, performs initial transmission using RB 1 and fails to receive allocation information (i.e. RB 2) from the base station at time t1, the DSA mobile station performs the first retransmission using RB 1 at time t3.

The sequence after time 1 is the same between FIG. 16 and FIG. 1. That is, when DSA mobile station 1 that was performing retransmission fails to receive allocation information, uplink data of DSA mobile station 1 collides with uplink data of DSA mobile station 2, and therefore ARQ control collapses.

To solve the problem shown in FIG. 16, base station 400 (see FIG. 17) according to the present embodiment employs the same basic configuration and performs the same basic operation as base station 100 according to Embodiment 1 (see FIG. 2). Here, only the differences between base station 400 and base station 100 will be explained.

Scrambling code selecting section 407 of base station 400 differs from scrambling code selecting section 107 of base station 100 in part of processing, and therefore will be assigned different reference numerals to indicate these differences.

Scrambling code selecting section 407 provides scrambling codes that vary between a case where a response signal is a response signal to uplink transmission immediately after allocation information is indicated and a case where a response signal is a response signal to uplink transmission immediately after NACK information is indicated. Then, scrambling section 108 scrambles a plurality of identical response signals received as input from repetition section 106, using one of different scrambling codes.

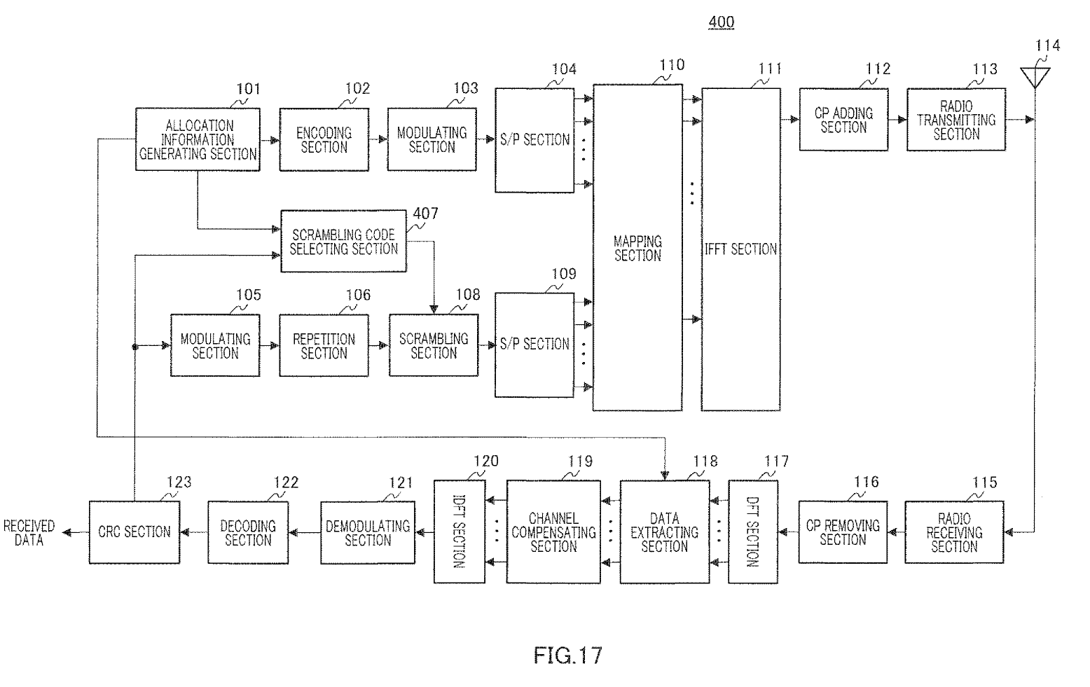

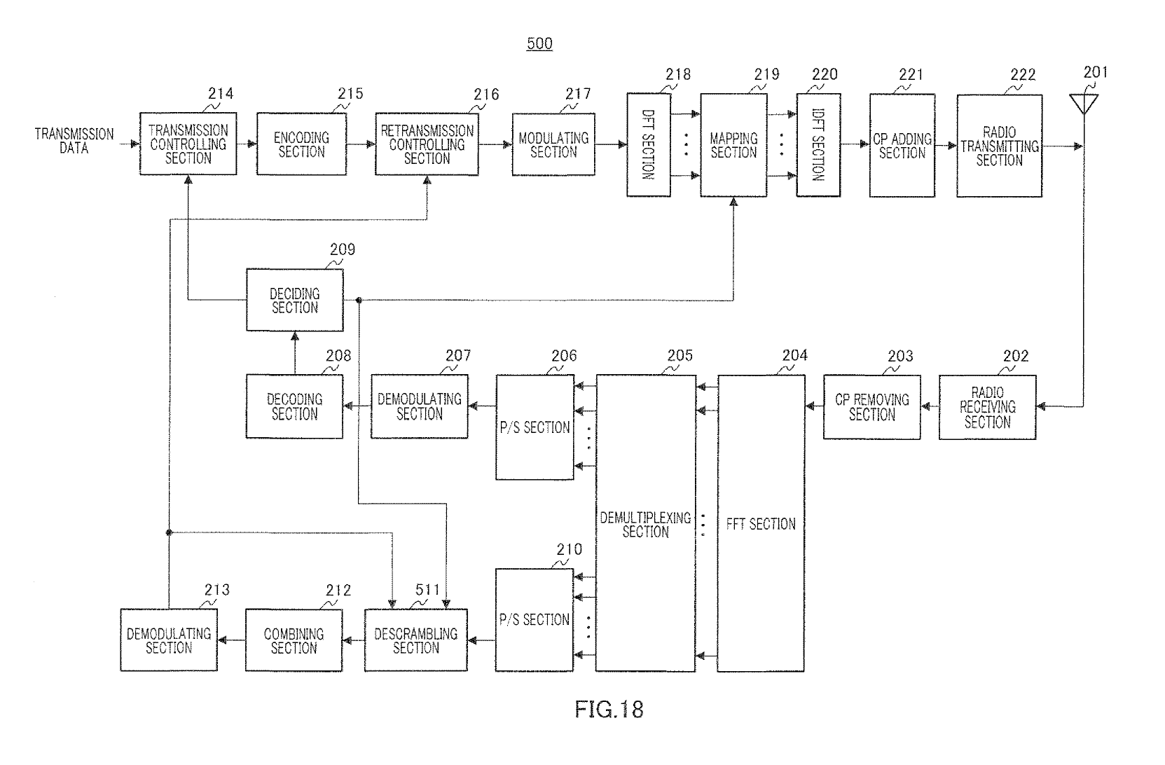

Further, mobile station 500 (see FIG. 18) according to the present embodiment employs the same configuration and performs the same basic operation as mobile station 200 (see FIG. 3) according to Embodiment 1. Here, only the differences between mobile station 500 and mobile station 200 will be explained.

Descrambling section 511 descrambles response signals using scrambling codes that vary between a case where uplink data is uplink transmission data immediately after allocation information is indicated and a case where uplink data is uplink transmission data immediately after NACK information is indicated.

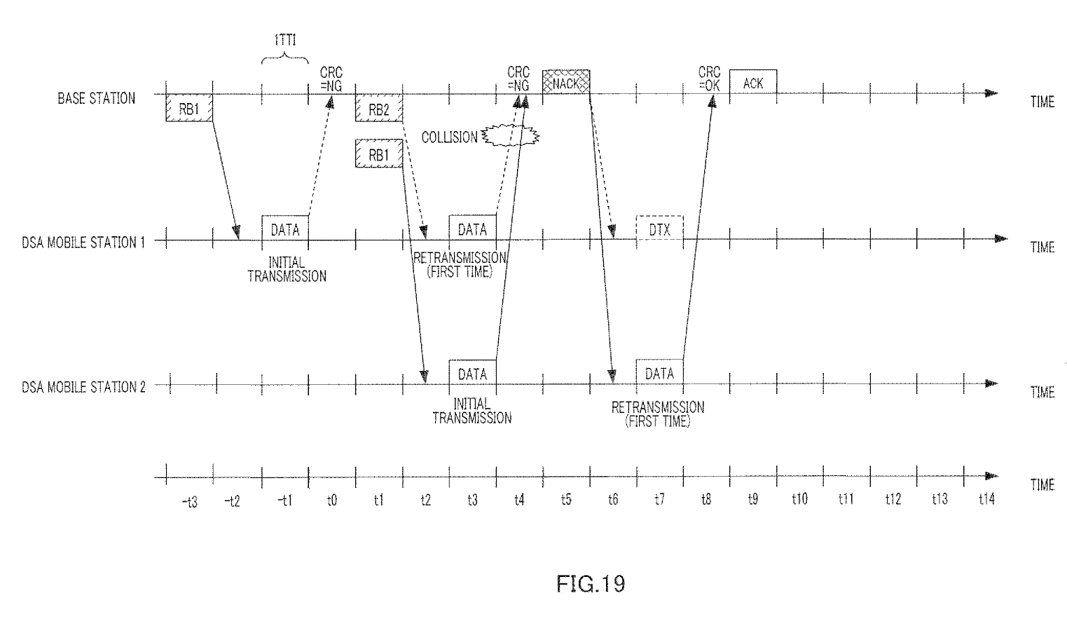

FIG. 19 is a sequence showing processings in base station 400, DSA mobile station 1 and DSA mobile station 2 according to the present embodiment. Further, FIG. 19 and FIG. 4 are basically the same, and therefore only the differences between FIG. 19 and FIG. 4 will be explained.

In FIG. 4, in case where the PSA mobile station performs uplink transmission before time t1 using RB 1 that is allocated in advance and fails to receive allocation information (i.e. RB 2) from the base station at time t1, the PSA mobile station performs uplink transmission using RB 1 again at time t3. Similar to this, in FIG. 19, in ease where DSA mobile station 1 performs initial transmission using RB 1 before time t1, fails to receive allocation information (i.e. RB 2) from the base station at time t1 and further decides that the response signal is a NACK, DSA mobile station 1 performs the first retransmission using RB 1 again at time t3.

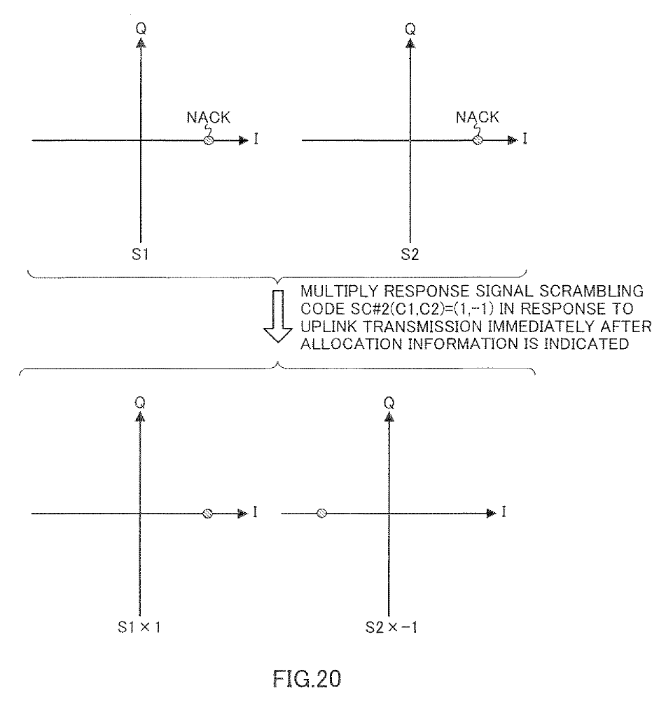

FIG. 20 shows scrambling processing of response signal channel number 1 associated with RB 1 in base station 400. Further, FIG. 20 and FIG. 6 are basically the same, and therefore detailed explanation thereof will be omitted. The differences between FIG. 20 and FIG. 6 are that, while a scrambling code for the DSA mobile station is used in FIG. 6, a response signal scrambling code in response to uplink transmission immediately after allocation information is indicated is used in FIG. 20.

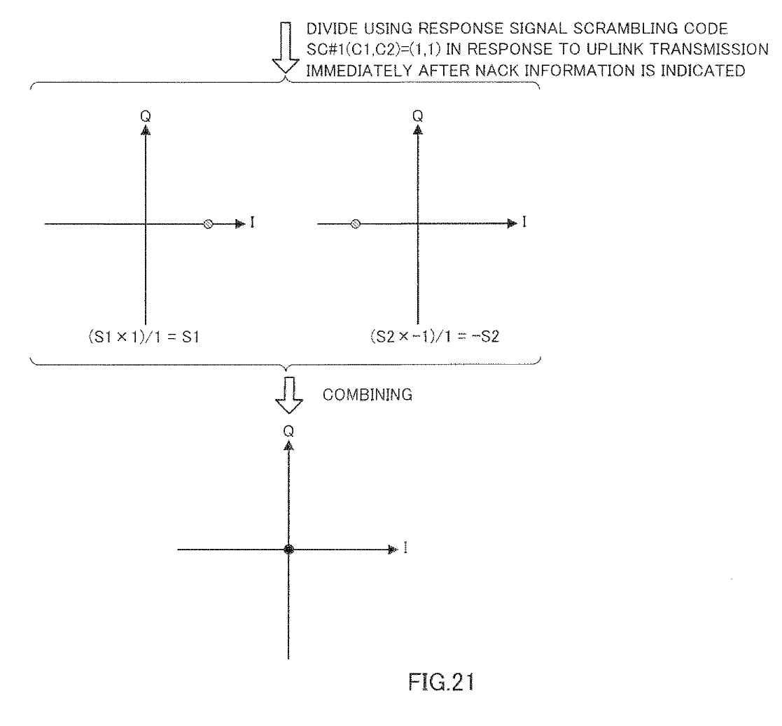

FIG. 21 shows descrambling processing in DSA mobile station 1. Further, FIG. 21 and FIG. 7 are basically the same, and therefore detailed explanation thereof will be omitted. The difference between FIG. 21 and FIG. 7 is that, while a scrambling code for the PSA mobile station is used in FIG. 7, a response signal scrambling code in response to uplink transmission immediately after NACK information is indicated is used in FIG. 21. DSA mobile station 1 decides that the response signal (i.e. NACK) from base station 400 is DTX, and stops transmission at time t7.

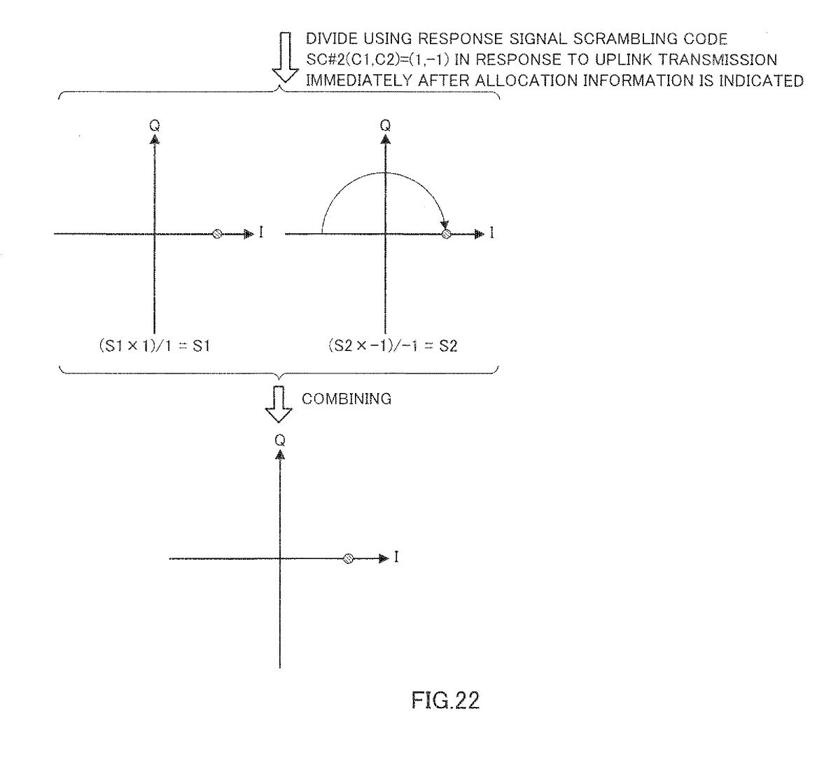

FIG. 22 shows descrambling processing in DSA mobile station 2. Further, FIG. 22 and FIG. 9 are basically the same, and therefore the detailed explanation thereof will be omitted. The difference between FIG. 22 and FIG. 9 is that, while a scrambling code for the DSA mobile station is used in FIG. 9, a response signal scrambling code in response to uplink transmission immediately after allocation information is indicated is used in FIG. 22. DSA mobile station 2 decides that the response signal (i.e. NACK) from base station 400 is a NACK, and performs retransmission (for the first time) at time t7.

Consequently, at time t8, uplink data from DSA mobile station 1 does not collide with uplink data from DSA mobile station 2, so that reception is OK in base station 400 (i.e. no error).

In this way, according to the present embodiment, in a mobile communication system that performs ARQ control by sharing a response signal channel between a plurality of mobile stations, in ease where uplink data retransmitted from a DSA mobile station that fails to receive allocation information (i.e. RB 2) collides with uplink data transmitted for the first time from the DSA mobile station that receives allocation information (i.e. RB 1), the base station scrambles repetition symbols in a response signal channel associated with RB 1, using a response signal scrambling code in response to uplink transmission immediately after allocation information is indicated. Consequently, while a DSA mobile station that receives allocation information (i.e. RB 1) acquires a NACK as a result of descrambling and performs retransmission, a DSA mobile station that fails to receive allocation information (i.e. RB 2) acquires DTX as a result of descrambling and stops transmission, so that it is possible to prevent collapse of ARQ control.

Further, although a method has been explained with the present embodiment for varying two of response signal scrambling codes in response to uplink transmission immediately after allocation information is indicated and response signal scrambling codes in response to uplink transmission immediately after NACK information is indicated, scrambling codes may be varied based on the number of retransmissions after allocation information is indicated. By this means, in FIG. 19, even when DSA mobile station 1 decides at time t7 that DTX is a NACK due to the influence of noise, it is possible to decide that the response signal for DSA mobile station 2 is DTX upon reception at DSA mobile station 1 at time t11.

Further, although a case has been explained with the present embodiment where, if uplink data is NG, whether to urge retransmission by indicating allocation information from the base station or retransmission by indicating a NACK is selected, it is possible to implement the present invention in the same way to select whether to urge retransmission by indicating allocation information and a NACK from the base station or retransmission by indicating only a NACK. In this ease, response signal scrambling codes in response to uplink transmission immediately after allocation information is indicated and response signal scrambling codes in response to uplink transmission in which allocation information is not indicated are varied.

Embodiments of the present invention have been explained.

Further, although cases have been explained with the above embodiments as examples where an allocation information indication channel number and a response signal channel number are associated on a one-to-one basis, the present invention is not limited to this and is also applicable to the case where a CCE (Control Channel Element) number in which an allocation information indication channel is multiplexed and a response signal channel number are associated.

Further, with the above embodiments, the base station may indicate scrambling codes used for each mobile station, to each mobile station using control information. Furthermore, it is also possible to determine in advance scrambling codes for use per mobile station.

With the above embodiments, although Hadamard codes utilizing both 1 and −1 are utilized as scrambling codes, the present invention is not limited to this and orthogonal codes may be used. Further, codes other than orthogonal codes may be used as long as amplitude values of symbols of response signals become small when different codes are used.

Also, in case where a stop signal for commanding to stop uplink data transmission is used instead of an ACK and a retransmit signal for commanding to resume uplink data transmission is used instead of a NACK, it is also possible to implement the present invention in the same way as the above embodiments.

Further, there are cases where a response signal is referred to as an “ACK/NACK signal.”

There are also cases where a response signal channel is referred to as “ACK/NACK CH,” “response channel,” or “HICH (Hybrid ARQ Indicator Channel).”

There are also cases where DTX is referred to as “NULL” meaning no received signal.

With the above embodiments, it is also possible to implement the present invention even in case where response signals of two users are multiplexed in one symbol by using QPSK (Quadrature Phase Shift Keying) as the modulation schemes for response signals.

Further, the present invention is not limited to the degree of repetition factors.

Furthermore, even in case where the identical signals are transmitted to a plurality of mobile stations that belong to a group, the present invention is applicable in the same way as the above embodiments.

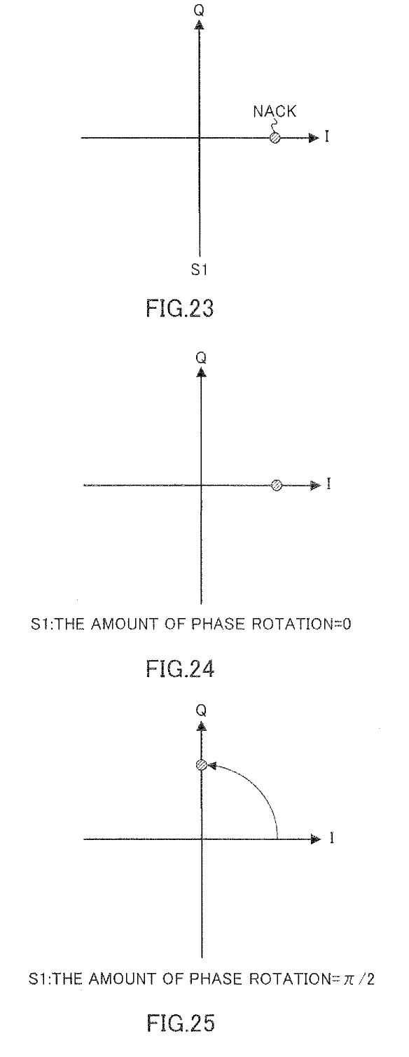

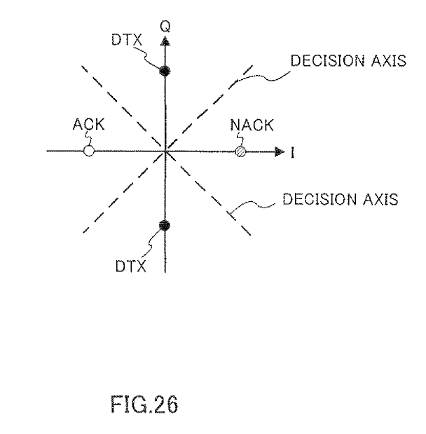

Also, by using phase rotation processing of applying phase rotation unique to each mobile station, to a response signal, it is possible to acquire the same function and operation as in the case where the above scrambling processing is used. For example, in ease where the response signal fed back from the base station is S1 shown in FIG. 23, a PSA mobile station does not apply phase rotation to S1 as shown in FIG. 24 and a DSA mobile station applies π/2 of phase rotation to S1 as shown in FIG. 25. Then, for example, according to the decision axis shown in FIG. 26, the PSA mobile station decides S1 of the amount of phase rotation=0, and the DSA mobile station decides S1 of the amount of phase rotation=π/2. Consequently, similar to Embodiment 1, the DSA mobile station decides that a NACK addressed to this DSA mobile station from the base station is a NACK, and the PSA mobile station decides that a NACK addressed to this DSA mobile station from the base station is DTX. Further, in case where the PSA mobile station performs binary (i.e. ACK or NACK) decision, the PSA mobile station does not apply phase rotation to S1 and the DSA mobile station applies phase rotation of the amount of phase rotation=π, so that the PSA mobile station can decide that a NACK addressed to the DSA mobile station from the base station is an ACK.

Also, there are cases where a mobile station is referred to as “UE,” a base station apparatus is referred to as a “Node B,” and a subcarrier is referred to as a “tone.” There are also cases where a CP is referred to as a “guard interval (“GI”).”

Further, the method for transforming between the frequency domain and the time domain is not limited to the IFFT, FFT, DFT and IDFT.

Furthermore, although the OFDM scheme has been explained as down link transmission scheme with the above embodiments, the downlink transmission scheme of the present invention is not particularly limited to this.

Still further, although cases have been explained with the above embodiments where frequency division multiplexing is used in uplink and RB 1 and RB 2 are allocated to two users at the same time, the same applies to the case where slot 1 and slot 2 or symbol 1 and symbol 2 are allocated to two users at the same time. Moreover, it is also possible to implement the present invention in the same way in case of code division multiplexing and spatial division multiplexing.

Although DFTs (Discrete Fourier Transform spread)-FDMA (Frequency Division Multiplex Access) scheme has been explained as the uplink transmission scheme with the above embodiments, the OFDM scheme and multicarrier scheme are also possible as long as they can perform frequency division multiplexing of users. Further, it is also possible to implement the uplink transmission scheme in case where time division multiplexing, code division multiplexing and spatial division multiplexing of users are performed, the uplink transmission scheme is not particularly limited even in this case.

Although there are cases where response signals are spread and transmitted or repeatedly transmitted to improve received quality, it is also possible to implement the present invention in the same way even in this case.

Further, control information is referred to as “control information” or “grant.” Furthermore, the present invention focuses on that UEID and CRC are added to allocation information, the probability of performing transmission using a wrong RB is very low immediately after allocation information is received, and the probability of performing transmission using a wrong RB is comparatively high in case where allocation information is not received (that is, in case where there is a possibility that reception of allocation information failed). Consequently, it is possible to implement the present invention regardless of the name of channels for indicating allocation information and the amount of time delay it takes until allocation is reflected after allocation information is indicated.

Also, although cases have been described with the above embodiments as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-211161, filed on Aug. 13, 2007, including the specification, drawings and abstract, is incorporated herein by reference in its entirety.

### INDUSTRIAL APPLICABILITY

The present invention is applicable to, for example, a mobile communication system.

1. A radio communication base station apparatus comprising:
an error detecting section that generates a response signal by performing error detection;
a selecting section that selects one of a plurality of scrambling codes; and
a scrambling section that scrambles a response signal using the scrambling code selected in the selecting section.

2. The radio communication base station apparatus according to claim 1, wherein the selecting section selects a scrambling code that varies between a case where the response signal is a response signal to reception of uplink data after uplink allocation information is transmitted and a case where the response signal is a response signal to reception of uplink data that does not transmit uplink allocation information.

3. The radio communication base station apparatus according to claim 1, wherein the selecting section selects a scrambling code that varies between a case where the response signal is a response signal to uplink data subjected to persistent scheduling and a case where the response signal is a response signal to uplink data subjected to dynamic scheduling.

4. The radio communication base station apparatus according to claim 1, wherein the selecting section selects a scrambling code that varies between a case where the response signal is a response signal to reception of uplink data after uplink allocation information is transmitted and a case where the response signal is a response signal to reception uplink data after NACK information is transmitted.

5. A radio communication mobile station apparatus comprising:
a selecting section that selects a scrambling code that varies between a case where the response signal is a response signal to transmission of uplink data after allocation information is received and a case where the response signal is a response signal to transmission of uplink data that does not receive uplink allocation information; and
a descrambling section that descrambles the response signal using the scrambling code selected in the selecting section.

6. A method for scrambling a response signal in automatic repeat request, comprising using a scrambling code that varies between a response signal that is a response signal to data transmitted in uplink using uplink allocation information and a response signal that is a response signal to data in uplink without using the uplink allocation information.
